(19) United States
(12) Patent Application Publication
(10) Pub. No.: US 2009/0246622 A1
(43) Pub. Date: Oct. 1, 2009

(54) Shock Isolation for a Battery

(76) Inventors: Carl Thelemann, East Islip, NY (US); Thomas Wulff, North Patchogue, NY (US); Timothy B. Austin, Stony Brooks, NY (US)

Correspondence Address: MOTOROLA, INC., 1303 EAST ALGONQUIN ROAD, IL01/3RD, SCHAUMBURG, IL, 60196, US

(21) Appl. No.: 12/057,890

(22) Filed: Mar. 28, 2008

(51) Int. Cl. H01M 2/10

(52) U.S. Cl. 429/186

(57) ABSTRACT

A battery includes a housing; a cell arrangement situated within the housing and storing a power; and a shock isolator disposed within the housing. The shock isolator absorbs an energy of a shock event upon the battery to prevent damage to the cell arrangement.

### FIELD OF THE INVENTION

The present invention relates generally to shock isolation for a battery. Specifically, a shock isolator is disposed within a battery housing to increase a ruggedness of the battery.

### BACKGROUND

A mobile unit (MU) may be used in a variety of environments. The varying conditions of these environments make the MU easily susceptible to damage. The MU may include a housing that is rugged to cope with the various conditions of the environments. For example, the MU may be dropped causing internal components of the MU to be damaged. The rugged housing may cushion the MU, for example, from a fall. Thus, components like the processor or the memory may stay intact.

However, for removable components such as a battery, the rugged housing may be insufficient to protect it from shock events such as dropping the MU. The removable component is separate from the housing and may not be afforded the protection thereof. Furthermore, the removable component may be susceptible to a greater shock as it is often placed in a recess of the MU. That is, the removable component further collides with the housing of the MU itself. Therefore, when the MU is subject to a shock event, the components of the MU may be safe, but the battery may be damaged. For example, the cells or circuitry of the battery may break. Aside from the battery having to be replaced, when the MU loses power (e.g., the battery no longer provides energy due to the damage), data and/or settings that are currently being used on the MU may become corrupted or lost.

### SUMMARY OF THE INVENTION

The present invention relates to a battery which includes a housing; a cell arrangement situated within the housing and storing a power; and a shock isolator disposed within the housing. The shock isolator absorbs an energy of a shock event upon the battery to prevent damage to the cell arrangement.

### DESCRIPTION OF THE DRAWINGS

FIG. 1 shows a battery according to an exemplary embodiment of the present invention.

FIG. 2 shows a first configuration of components for the battery of FIG. 1 according to an exemplary embodiment of the present invention.

FIG. 3 shows a second configuration of components for the battery of FIG. 1 according to another exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a shock isolation arrangement for a battery. The shock isolation arrangement may be configured to absorb energy from a shock event (e.g., drop) occurring on an electronic device in which the battery is housed. Specifically, the shock isolation arrangement protects a cell assembly/arrangement of the battery so that energy may continue to be provided to the electronic device. The battery, the shock isolation arrangement, and the cell assembly will be discussed in further detail below.

It should be noted that the exemplary embodiments of the present invention may be embodied in a battery for any electronic device. For example, the electronic device may be portable or stationary. That is, the shock isolation arrangement may be used for a battery that is removably connected to the electronic device where the electronic device may be susceptible to any shock event. For example, a portable device (e.g., a personal digital assistant) may be dropped or inadvertently hit; a stationary device (e.g., a computer tower) may be hit (e.g., kicked); etc. The battery may be disposed within a housing of the electronic device, in particular in a recess configured to receive the battery.

It should also be noted that the term “battery” may represent any portable power supply capable of supplying energy to an electronic device. The portable power supply may also include, for example, a capacitor or supercapacitor. That is, the exemplary embodiments of the present invention may also be embodied in other forms of portable power supplies with corresponding components to the battery being protected with the shock isolation arrangement.

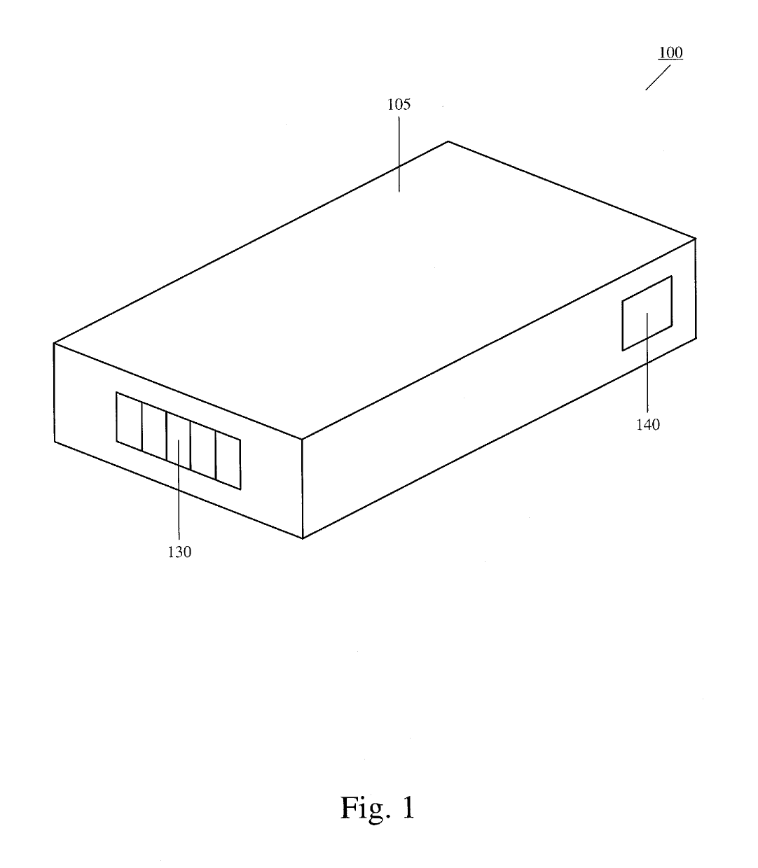

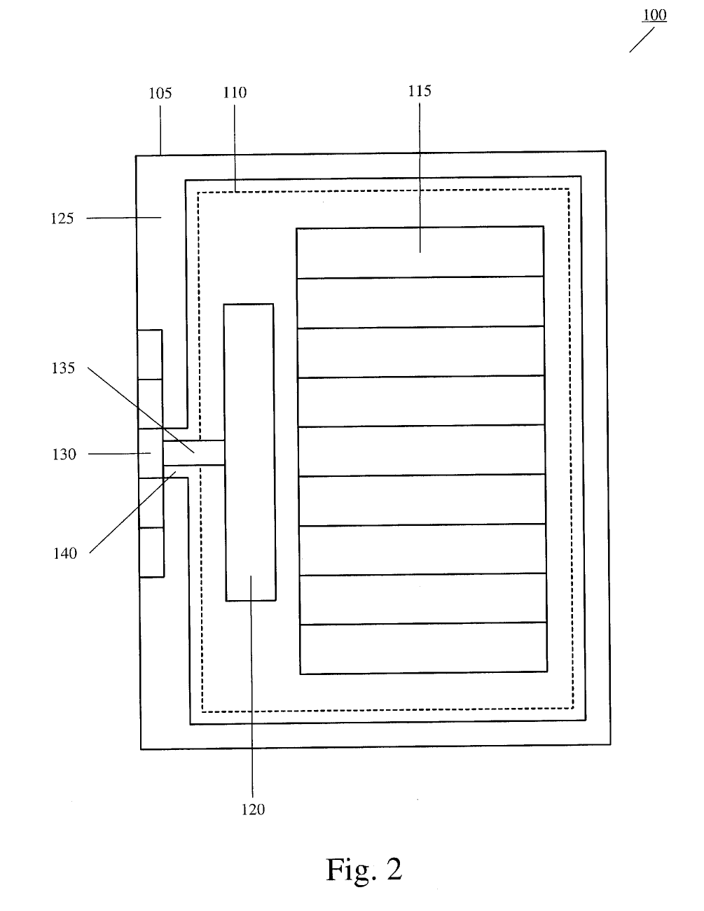

FIG. 1 shows a battery 100 according to an exemplary embodiment of the present invention. Specifically, FIG. 1 illustrates an outer view of the battery 100. The outer view of the battery 100 shows a housing 105, contacts 130, and a locking mechanism 140. The contacts 130 will be discussed in further detail below with reference to FIG. 2.

The housing 105 may be a casing in which components of the battery 100 may be at least partially disposed. That is, the components of the battery 100 may be wholly or partially within the housing 105. As will be described in further detail below, the battery 100 may include, for example, power cells, a circuitry, the contacts 130, etc. The power cells and the circuitry may be wholly disposed within the housing 105. The contacts 130 may be disposed partially within the housing 105 so that a portion of the contacts 130 are disposed on a periphery of the housing 105 (e.g., may be recessed in the housing 105). Thus, the contacts 130 may couple to corresponding contacts of an electronic device.

The locking mechanism 140 may be any arrangement used to secure the battery 100 with the housing 105 (e.g., to have a proper orientation with respect to the electronic device in which the battery 100 provides energy. The locking mechanism 140 may be part of a mechanical lock, an electrical lock, or a combination thereof. For example, the locking mechanism 140 may be a recess in which a latch (not shown) disposed on the electronic device is received. Specifically, the latch may be disposed in a recess in which the battery 100 is to be received. In another example, the locking mechanism 140 may be a pin recess in which a locking pin adjusted by a solenoid may be received. It should be noted that the battery 100 including the locking mechanism 140 is only exemplary. In other exemplary embodiments, the battery 100 may not include the locking mechanism 140. For example, the electronic device may include a recess to receive the battery 100. The electronic device may also include a lid to cover the recess upon reception of the battery 100.

FIG. 2 shows a first configuration of components for the battery 100 of FIG. 1 according to an exemplary embodiment of the present invention. As discussed above, the battery 100 may include the housing 105 in which components of the battery 100 are encased. Furthermore, the battery 100 may include the shock isolation arrangement. According to the exemplary embodiments of the present invention, the components of the battery 100 may include the housing 105, a cell assembly 110, a shock isolator 125, the contacts 130, and connector 135.

The cell assembly 110 may include a single cell (not shown) or a plurality of cells 115 and a circuitry 120. The plurality of cells 115 may be the component of the battery 100 that stores energy to be provided to the electronic device. The plurality of cells 115 may be rechargeable. For example, the plurality of cells 115 may be Ni—Cd, Ni—H, Li—H, LitIon, etc. The circuitry 120 may be a component of the battery 100 that controls output of the energy stored in the plurality of cells 115. Specifically, the circuitry 120 may convert the energy from the plurality of cells 115 into power signals. For example, depending on the voltage of the battery 100, a corresponding voltage may be output from the battery 100 to the electronic device. The circuitry 120 may also control a recharging of the plurality of cells 115. That is, when the battery 100 is being recharged, energy drawn may be stored in the plurality of cells 115 upon a conversion through the circuitry 120.

The contacts 130 may provide a first part for electrically connecting the battery 100 to the electronic device. The contacts 130 may couple to corresponding contacts of the electronic device to establish the connection. The corresponding contacts may also be disposed in a recess of the electronic device that receives the battery 100. The contacts 130 may be conducting areas shaped as, for example, flat heads, pins, recesses, etc. The corresponding contacts may exhibit a respective shape with respect to the contacts 130.

The connector 135 may electrically connect the circuitry 120 to the contacts 130. Specifically, the connector 135 may be a conduit in which energy converted by the circuitry 120 is transmitted to the contacts 130, or vice versa. According to the exemplary embodiments of the present invention, the connector 135 may be a flexible printed circuit. The flexibility of the connector 135 enables the cell assembly 110 to “float” within the housing 105. As will be explained in detail below, when the cell assembly 110 is cushioned, the cell assembly 110 may slightly move. A rigid connection from the circuitry 120 to the contacts 130 may cause a break in the connector 135. The flexibility of the connector 135 may allow slight movements in the cell assembly 110 to be compensated.

The shock isolator 125 may be a component of the shock isolation arrangement. The shock isolator 125 may absorb any energy from a shock event such as a dropping or banging of the battery pack or indirectly through a dropping or banging of the electronic device. The shock isolator 125 is configured to protect the cell assembly 110 from receiving the energy of the shock event, thereby preventing any damage thereto.

The shock isolator 125 may be manufactured using a variety of materials. In a first example, the shock isolator 125 may be a stamped/diecut foam part. In a second example, the shock isolator 125 may be an injection molding thermoplastic part. In a third example, the shock isolator is an injection/compression molded silicon part. In a fourth example, a combination of the above described materials may be used for the shock isolator 125. Any of these materials may enable the cell assembly 110 to “float” within the housing 105. For example, if the battery 100 is dropped, the cell assembly 110 may push against the shock isolator 125 (in the direction of the fall). The energy from the pushing due to the drop may be absorbed by the shock isolator 125. The cushioning of the cell assembly 110 prevents damage thereto.

According to the exemplary embodiment of the battery 100 illustrated in FIG. 2, the shock isolator 125 may be disposed within the housing 105. Specifically, the shock isolator 125 may surround (i.e., fully wrap) the cell assembly 110. The shock isolator 125 may also include a recess in which the contacts 130 are disposed. However, because the shock isolator 125 is flexible or if the contacts 130 are disposed outside the housing 105, the shock isolator 125 may not include the recess. The shock isolator 125 may also include a via in which the connector 135 is disposed. For example, a slit via 140 may extend from an inner wall of the shock isolator 125 (i.e., near the circuitry 120) to an outer wall of the shock isolator 125 (i.e., near the contacts 130). The connector 135 may be within the slit via 140. Any of the materials described above for the shock isolator 125 may also facilitate the “floating” of the cell assembly 110 as the connector 135 may move within the slit via 140.

It should be noted that the shock isolator 125 surrounding the cell assembly 110 may be configured in a variety of ways. For example, a complete surrounding of the shock isolator 125 may entail covering the cell assembly 110 in between any area in which the cell assembly 110 may contact an inner wall of the housing 105. In another example, a surrounding of the shock isolator 125 may entail covering a predetermined number of sides of the cell assembly 110 such as on a top and bottom face, all four side faces, etc.

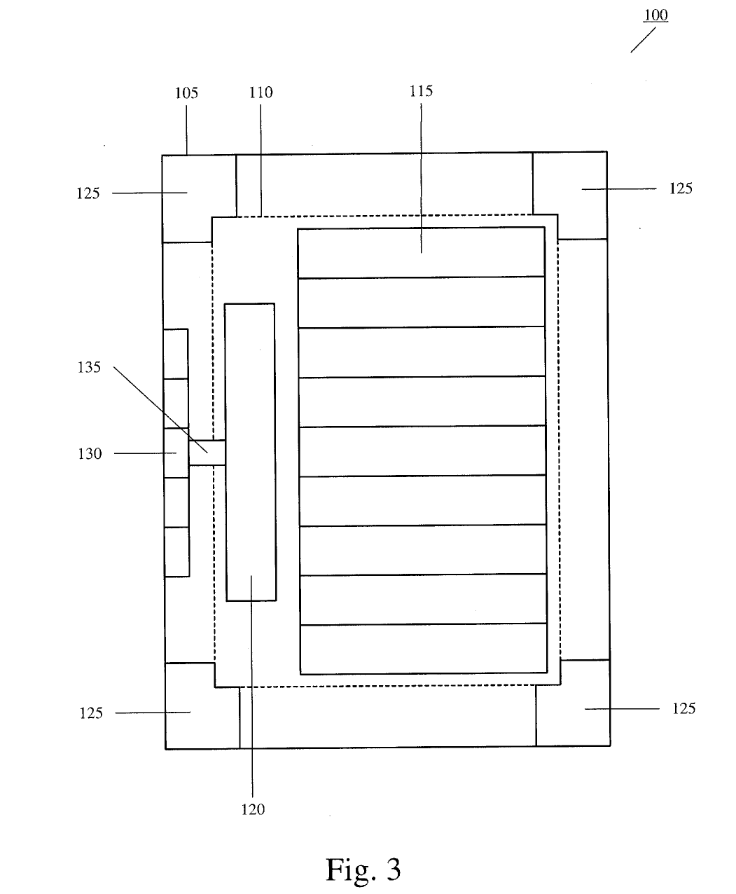

FIG. 3 shows a second configuration of components for the battery 100 of FIG. 1 according to another exemplary embodiment of the present invention. The second configuration of components may be substantially similar to the first configuration of components of FIG. 1. Specifically, the types of components may be identical. That is, the second configuration may also include the housing 105, the cell assembly 110 (including the plurality of cells 115 and the circuitry 120), the shock isolator 125, the contacts 130, and the connector 135. However, the second configuration illustrates another form of the shock isolator 125.

The shock isolator 125 of the second configuration includes a plurality of parts that are disposed in predetermined locations around the cell assembly 110. For example, as illustrated, the shock isolator 125 includes four parts where each part is disposed at each corner of the cell assembly 110. It may be determined during a testing phase that cushioning selected areas of the cell assembly 110 during a shock event prevents most or all damage thereto. Thus, the second configuration may be a result of the testing.

It should be noted that the second configuration including a part of the shock isolator 125 at each corner of the cell assembly 110 is only exemplary. Specifically, the second configuration may represent the shock isolation arrangement using a predetermined setting for the cell assembly. That is, other settings determined, for example, during the testing phase, may be used and represented with the second configuration. For example, the shock isolator 125 may again include four parts. However, the parts may be disposed on the sides of the cell assembly 110 but not at the corners where the shock isolator 125 is disposed in the second configuration of FIG. 3. This setting may also be used when it is determined that such a configuration also prevents most or all damage during a shock event.

It should also be noted that the shock isolator 125 being disposed only between the housing 105 and the cell assembly 110 is only exemplary. In other embodiments, the shock isolator 125 may be placed in other locations. For example, the shock isolator 125 may additionally be placed outside the housing 105. A layer of the shock isolator 125 around the housing 105 may decrease an energy from a shock event to the housing 105 which would further decrease the energy from the shock event to the cell assembly 110 as the shock isolator 125 is disposed therebetween. In another example, the shock isolator 125 may be manufactured of an insulating material and disposed within the cell assembly 110. Thus, an additional cushioning of the components of the cell assembly 110 may be had, thereby substantially ensuring a prevention of damage to the components.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

1. A battery, comprising:
a housing;
a cell arrangement situated within the housing, the cell arrangement including at least one cell storing a power;
a shock isolator disposed within the housing, the shock isolator absorbing an energy of a shock event upon the battery to prevent damage to the cell arrangement and
a circuitry, within the housing, controlling an exchange of the power with an electronic device.

2. The battery of claim 1, further comprising:
a connector connecting the circuitry with a plurality of contacts, the plurality of contacts coupling to a plurality of corresponding contacts of the electronic device to establish a connection for the exchange.

3. The battery of claim 2, wherein the connector is a flexible printed circuit.

4. The battery of claim 1, wherein the shock isolator is one of a stamped/diecut foam part, an injection molding thermoplastic part, an injection/compression molded silicon part, and a combination thereof.

5. The battery of claim 2, wherein the shock isolator is wrapped around the cell arrangement.

6. The battery of claim 5, wherein the shock isolator includes a slit via in which the connector is disposed.

7. The battery of claim 1, wherein the shock isolator is disposed within the housing at predetermined locations.

8. The battery of claim 7, wherein the predetermined locations include each corner of the cell arrangement.

9. The battery of claim 1, wherein the shock isolator is further disposed outside the housing.

10. The battery of claim 1, wherein the shock isolator is further disposed within the cell arrangement.

11. The battery of claim 2, wherein the exchange includes sending the power to the electronic device and receiving the power to recharge the at least one cell.

12. The battery of claim 1, wherein the battery is received in a recess of an electronic device.

13. The battery of claim 12, further comprising:
a locking mechanism disposed at least partially on a periphery of the housing.

14. The battery of claim 13, wherein the locking mechanism is one of mechanical, electrical, and a combination thereof.

15. An arrangement, comprising:
a shock isolator disposed within a housing of a battery, the battery including a cell arrangement situated within the housing, the cell arrangement including at least one cell storing a power; and
a connector connecting the cell arrangement to a plurality of contacts of the battery, the connector including a flexible printed circuit,
wherein the shock isolator and the connector are configured to absorb an energy of a shock event upon the battery to prevent damage to the cell arrangement.

16. The arrangement of claim 15, wherein the shock isolator is one of a stamped/diecut foam part, an injection molding thermoplastic part, an injection/compression molded silicon part, and a combination thereof.

17. The arrangement of claim 15, wherein the shock isolator is wrapped around the cell assembly.

18. The arrangement of claim 17, wherein the shock isolator includes a slit via in which the connector is disposed.

19. The arrangement of claim 15, wherein the shock isolator is disposed within the housing at predetermined locations.

20. The arrangement of claim 19, wherein the predetermined locations include each corner of the cell assembly.

21. A battery arrangement, comprising:
power storing means for storing a power;
housing means for housing the power storing means; and
shock isolating means for absorbing an energy of a shock event upon the battery arrangement to prevent damage to the power storing means, the shock isolating means being disposed within the housing means.
